(19) United States
(12) Patent Application Publication
(10) Pub. No.: US 2010/0331229 A1
(43) Pub. Date: Dec. 30, 2010

(54) BLEACHING COMPOSITIONS COMPRISING A PERFUME DELIVERY SYSTEM

(76) Inventors: Giulia Ottavia Bianchetti, Rome (IT); Gloria Dicapua, Rome (IT); Andrea Esposito, Rome (IT); Sarah Germana, Rome (IT); Vincenzo Guida, Rome (IT); Luca Sarcinelli, Cerveteri (IT)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/826,747

(22) Filed: Jun. 30, 2010

(30) Foreign Application Priority Data
Jun. 30, 2009 (EP) 09164132.4

(51) Int. Cl. C11D 3/395

(52) U.S. Cl. 510/302; 252/186.1; 252/186.38

(57) ABSTRACT

Particulate bleaching composition comprising a bleaching system, as a first essential component, which comprises oxygen bleach, a bleach activator and a perfume delivery system. Such perfume delivery system is preferably chosen among an amine reaction product containing perfume or an encapsulated perfume made of starch.

### FIELD OF THE INVENTION

The present invention relates to particulate bleaching compositions comprising oxygen bleach or mixtures thereof, a bleach activator and a perfume delivery system.

### BACKGROUND OF THE INVENTION

Bleach-containing compositions for bleaching various surfaces, such as fabrics, are well known in the art. Commonly encountered particulate bleaching compositions are mainly based on hypochlorite bleaches or on oxygen bleaches, such as peroxygen bleaches.

Particulate bleaching compositions based on peroxygen bleaches are based on so-called persalt bleaches such as sodium perborate, in its various hydrate forms, or on sodium percarbonate. Such persalt bleaches are sources of hydrogen peroxide when used in aqueous washing conditions. However, such peroxygen bleaching compositions are sometimes considered as less efficient than hypochlorite bleaches compositions.

Typically, to overcome such poor bleaching performance of hydrogen peroxide, persalt bleaches are formulated in granular compositions with bleach activators.

However, a major drawback associated with the use of certain bleach activators is the malodor they generate, mainly during storage. Indeed, not only the compositions itself have an unpleasant smell but the malodor remains sometimes noticeable on surfaces or fabrics which have been treated with said composition.

Formulators have tried to solve that problem by designing perfumed bleaching compositions However, this has been difficult for many reason, mainly for the fact that very few perfume components stable in such an oxidative environments. Furthermore, the malodor generated by bleach activator is strong and even sometimes difficult to mask.

It is thus an object of the present invention to provide an effective bleaching composition having a pleasant odor which delivers effective bleaching performance on stained fabrics. The applicant has now found that the particulate bleaching composition comprising a bleach activator and specific perfume delivery system, when used in laundry applications meets the above objective. Thus, an advantage of the composition of the present invention is that provide a good smell to the composition itself and to the fabrics and/or surfaces treated with it while still having excellent bleaching performances.

Another advantage of the compositions of the present invention is that they exhibit also effective stain removal performance on various stains including enzymatic stains and/or greasy stains.

A further advantage of the compositions of the present invention is that the particulate bleach additives herein are suitable for the bleaching of different types of fabrics including natural fabrics, (e.g., fabrics made of cotton, and linen), synthetic fabrics such as those made of polymeric fibres of synthetic origin (e.g., polyamide-elasthane) as well as those made of both natural and synthetic fibres. For example, the particulate bleach additives of the present invention herein may be used on synthetic fabrics despite a standing prejudice against using bleaches on synthetic fabrics, as evidenced by warnings on labels of clothes and commercially available bleaching compositions like hypochlorite-containing compositions.

### SUMMARY OF THE INVENTION

The present invention relates to particulate bleaching composition comprising: a bleaching system, as a first essential component, which comprises oxygen bleach, a bleach activator and a perfume delivery system; the perfume delivery system being preferably selected from an amine reaction product containing perfume or an encapsulated perfume made of starch.

### DETAILED DESCRIPTION OF THE INVENTION

### The Particulate Bleach Additive Composition

The particulate bleaching compositions herein are so called particulate bleach additive compositions suitable for use in conjunction with a conventional laundry detergent, and in particular with particulate laundry detergents, to treat (stained) fabrics. The terms “additive” or “through-the-wash (bleaching) composition” refer to compositions that are preferably employed in the specific process of treating, preferably bleaching, fabrics as encompassed by the present invention.

Indeed, additive compositions are added together with a conventional laundry detergent (preferably particulate laundry detergent) into a washing machine and are active in the same wash-cycle. By contrast, so-called ‘spotter’ or ‘pretreater’ compositions that are applied, mostly undiluted, onto fabrics prior to washing or rinsing the fabrics and left to act thereon for an effective amount of time. Furthermore, so-called ‘soakers’ or ‘rinse-added’ compositions are contacted, mostly in diluted form, with fabrics prior or during rinsing of fabrics with water.

The bleach additive compositions herein are particulate compositions. By “particulate” it is meant herein powders, pearls, granules, tablets and the like. Particulate compositions are preferably applied onto the fabrics to be treated dissolved in, an appropriate solvent, typically water.

The particulate bleach additive composition herein have a pH measured at 25° C., preferably of at least, with increasing preference in the order given, 0.1, 0.5, 1, 1.5, 2, 2.5, 3, 3.5, 4, 4.5, 5, 5.5, 6, 6.5, 7, when diluted into 1 to 500 times its weight of water. Independently, particulate bleach additive composition herein have a pH measured at 25° C., preferably of no more than, with increasing preference in the order given, 12, 11.5, 11, 10.5, 10, 9.5, 9, 8.5 or 8, when diluted into 1 to 500 times its weight of water.

The compositions of the present invention are granular compositions. These compositions can be made by a variety of methods well known in the art, including dry-mixing, spray drying, agglomeration and granulation and combinations thereof. The compositions herein can be prepared with different bulk densities, from conventional granular products to so called “concentrated” products (i.e., with a bulk density above 600 g/l).

### The Oxygen Bleach

As an essential ingredient, the compositions according to the present invention comprises oxygen bleach. Preferably said oxygen bleach is a peroxygen source, more preferably hydrogen peroxide source.

Examples of the addition compounds of hydrogen peroxide include inorganic perhydrate salts, the compounds hydrogen peroxide forms with organic carboxylates, urea, and compounds in which hydrogen peroxide is clathrated.

Examples of inorganic perhydrate salts include perborate, percarbonate, perphosphate and persilicate salts. The inorganic perhydrate salts are normally the alkali metal salts. The alkali metal salts of percarbonate, perborate or mixtures thereof, are the preferred inorganic perhydrate salts for use herein. Preferred alkali metal salt of percarbonate is sodium percarbonate.

In a preferred embodiment of the present invention, the oxygen bleach is a peroxygen source, preferably an alkali metal salt of percarbonate, more preferably sodium percarbonate.

Other suitable oxygen bleaches include persulphates, particularly potassium persulphate K₂S₂O₈ and sodium persulphate Na₂S₂O₈. Examples of inorganic perhydrate salts include perborate, percarbonate, perphosphate and persilicate salts. The inorganic perhydrate salts are normally the alkali metal salts.

The alkali metal percarbonate bleach is usually in the form of the sodium salt. Sodium percarbonate is an addition compound having a formula corresponding to 2Na₂CO₃ 3H₂O₂. To enhance storage stability the percarbonate bleach can be coated with, e.g., a further mixed salt of an alkali metal sulphate and carbonate. Such coatings together with coating processes have previously been described in GB 1466799. The weight ratio of the mixed salt coating material to percarbonate lies in the range from 1:2000 to 1:4, more preferably from 1:99 to 1:9, and most preferably from 1:49 to 1:19. Preferably, the mixed salt is of sodium sulphate and sodium carbonate which has the general formula Na₂SO₄.n.Na₂CO₃ wherein n is from 0.1 to 3, preferably n is from 0.3 to 1.0 and most preferably n is from 0.2 to 0.5.

Commercially available carbonate/sulphate coated percarbonate bleach may include a low level of a heavy metal sequestrant such as EDTA, 1-hydroxyethylidene 1,1-diphosphonic acid (HEDP) or an aminophosphonate, that is incorporated during the manufacturing process.

Preferred heavy metal sequestrants for incorporation as described herein above include the organic phosphonates and amino alkylene poly(alkylene phosphonates) such as the alkali metal ethane 1-hydroxy diphosphonates, the nitrilo trimethylene phosphonates, the ethylene diamine tetra methylene phosphonates and the diethylene triamine penta methylene phosphonates.

Typically, the compositions of the present invention comprise from 10% to 80% by weight of the total composition of oxygen bleach, preferably from 15% to 70% and more preferably from 20% to 60%.

Preferably, the compositions herein typically contain from 10% to 80%, preferably from 15% to 70% by weight, most preferably from 20% to 60% by weight of an alkali metal percarbonate bleach (when expressed on an AvOx basis of 13.5%) in the form of particles having a mean size from 250 to 900 micrometers, preferably 500 to 700 micrometers.

### Bleach Activators

Typically to overcome poor bleaching performance of oxygen bleaches, persalt bleaches are formulated in granular compositions with so-called bleach activators. The bleach activators are species that react with hydrogen peroxide to form a peroxyacid or peracid.

Thus, as another essential ingredient, the compositions according to the present invention comprise oxygen bleach.

In a preferred embodiment, the bleach activator used in the liquid bleach composition has the general formula:

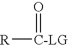

wherein R is an alkyl group, linear or branched, containing from about 1 to 11 carbon atoms and LG is a suitable leaving group. As used herein, a “leaving group” is any group that is displaced from the bleach activator as consequence of nucleophilic attack on the bleach activator by the perhydroxide anion, i.e. perhydrolysis reaction.

Generally, a suitable leaving group is electrophilic and is stable such that the rate of the reverse reaction is negligible. This facilitates the nucleophilic attack by the perhydroxide anion. The leaving group must also be sufficiently reactive for the reaction to occur within the optimum time frame, for example during the wash cycle. However, if the leaving group is too reactive, the bleach activator will be difficult to stabilize. In the past, those skilled in the art have not been successful in formulating an aqueous liquid bleach having the desired stability for a practical shelf-life.

These characteristics are generally paralleled by the pKa of the conjugate acid of the leaving group, although exceptions to this convention are known. The conjugate acid of the leaving group in accordance with the present invention preferably has a pKa in a range from about 4 to about 13, more preferably from about 6 to about 11, and most preferably from about 8 to about 11.

Preferably, the leaving group has the formula:

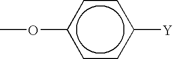

wherein Y is selected from the group consisting of SO₃⁻M⁺, COO⁻M⁺, SO₄M⁺, PO₄M⁺, PO₃⁻M⁺. (N⁺R²₃)X⁻ and O←N(R²₂), M is a cation and X is an anion, both of which provide solubility to the bleach activator, and R² is an alkyl chain containing from about 1 to about 4 carbon atoms or H. In accordance with the present invention, M is preferably an alkali metal, with sodium being most preferred. Preferably, X is a hydroxide, methylsulfate or acetate anion.

Other suitable leaving groups have the following formulas

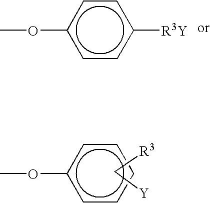

wherein Y is the same as described above and R³ is an alkyl chain containing from about 1 to about 8 carbon atoms, H or R².

While numerous bleach activators as described above are suitable for use in the present liquid bleach composition, a preferred bleach activator has the formula:

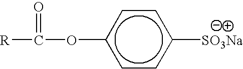

wherein R is an alkyl chain, linear or branched, containing from 1 to 11 carbon atoms. More preferably, R is an alkyl chain, linear or branched, containing from 3 to 11, even more preferably from 8 to 11.

Most preferably, according to the present invention, the bleach activator has the formula:

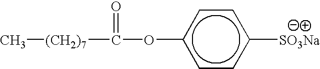

which is also referred to as sodium n-nonyloxybenzene sulfonate (hereinafter referred to as “NOBS”).

This bleach activator and those described previously may be readily synthesized by well known reaction schemes or purchased commercially, neither of which is more preferred. Those skilled in the art will appreciate that other bleach activators beyond those described herein which are readily water-soluble can be used in the present bleach composition without departing from the scope of the invention.

Typically, the compositions of the present invention might comprise from 1% to 30% by weight of the total composition of a bleach activators, preferably from 2% to 20% and more preferably from 3% to 10%.

The bleaching mechanism generally, and the surface bleaching mechanism in particular, in the washing solution are not completely understood. While not intending to be limited by theory, however, it is believed that the bleach activator undergoes nucleophilic attack by a perhydroxide anion, for example from aqueous hydrogen peroxide, to form a percarboxylic acid. This reaction is commonly referenced in the art as perhydrolysis.

A second species present in the washing solution is the diacylperoxide (also referred to herein as “DAP”). It is imperative that some DAP production is present in order to improve bleaching of specific stains such as, for example, those stains caused by spaghetti sauce or barbecue sauce. The peroxyacid acids are particularly useful for removing dingy soils from textiles. As used herein, “dingy soils” are those which have built up on textiles after numerous cycles of usage and washing and thus, cause the white textile to have a gray or yellow tint. Accordingly, the bleaching mechanism herein preferably produces an effective amount of peroxyacid and DAP to bleach both dingy stains as well as stains resulting from spaghetti and the like.

Further, it is believed that bleach activators within the scope of the invention render the peroxygen bleaches more efficient even at bleach solution temperatures wherein the bleach activators are not necessary to activate the bleach, for example at temperatures above 60° C. As a consequence, less peroxygen bleach is required to obtain the same level of surface bleaching performance as compared with peroxygen bleach alone.

Preferred mixtures of bleach activators herein comprise n-nonanoyloxybenzene-sulphonate (NOBS) together with a second bleach activator having a low tendency to generate diacyl peroxide, but which delivers mainly peracid. Said second bleach activators may include tetracetyl ethylene diamine (TAED), acetyl triethyl citrate (ATC), acetyl caprolactam, benzoyl caprolactam and the like, or mixtures thereof. Indeed, it has been found that mixtures of bleach activators comprising n-nonanoyloxybenzene-sulphonate and said second bleach activators, contribute to further boost particulate soil removal performance while exhibiting at the same time good performance on diacyl peroxide sensitive soil (e.g., beta-carotene) and on peracid sensitive soil (e.g., body soils).

The Perfume Delivery System

The compositions of the present invention comprise as another essential ingredient a perfume delivery system. By perfume delivery system, it is meant herein a system able to provide a perfume to the composition as well as long lasting perfume benefits to the fabric treated with said composition. Suitable perfume delivery systems, methods of making certain perfume delivery systems and the uses of such perfume delivery systems are disclosed in USPA 2007/0275866 A1. Such perfume delivery systems include:

I. Polymer Assisted Delivery (PAD): This perfume delivery technology uses polymeric materials to deliver perfume materials. Classical coacervation, water soluble or partly soluble to insoluble charged or neutral polymers, liquid crystals, hot melts, hydrogels, perfumed plastics, microcapsules, nano- and micro-latexes, polymeric film formers, and polymeric absorbents, polymeric adsorbents, etc. are some examples. PAD includes but is not limited to:
a.) Matrix Systems: The fragrance is dissolved or dispersed in a polymer matrix or particle. Perfumes, for example, may be 1) dispersed into the polymer prior to formulating into the product or 2) added separately from the polymer during or after formulation of the product. Diffusion of perfume from the polymer is a common trigger that allows or increases the rate of perfume release from a polymeric matrix system that is deposited or applied to the desired surface (situs), although many other triggers are know that may control perfume release. Absorption and/or adsorption into or onto polymeric particles, films, solutions, and the like are aspects of this technology. Nano- or micro-particles composed of organic materials (e.g., latexes) are examples. Suitable particles include a wide range of materials including, but not limited to polyacetal, polyacrylate, polyacrylic, polyacrylonitrile, polyamide, polyaryletherketone, polybutadiene, polybutylene, polybutylene terephthalate, polychloroprene, poly ethylene, polyethylene terephthalate, polycyclohexylene dimethylene terephthalate, polycarbonate, polychloroprene, polyhydroxyalkanoate, polyketone, polyester, polyethylene, polyetherimide, polyethersulfone, polyethylenechlorinates, polyimide, polyisoprene, polylactic acid, polymethylpentene, polyphenylene oxide, polyphenylene sulfide, polyphthalamide, polypropylene, polystyrene, polysulfone, polyvinyl acetate, polyvinyl chloride, as well as polymers or copolymers based on acrylonitrile-butadiene, cellulose acetate, ethylene-vinyl acetate, ethylene vinyl alcohol, styrene-butadiene, vinyl acetate-ethylene, and mixtures thereof.
   “Standard” systems refer to those that are “pre-loaded” with the intent of keeping the pre-loaded perfume associated with the polymer until the moment or moments of perfume release. Such polymers may also suppress the neat product odor and provide a bloom and/or longevity benefit depending on the rate of perfume release. One challenge with such systems is to achieve the ideal balance between 1) in-product stability (keeping perfume inside carrier until you need it) and 2) timely release (during use or from dry situs). Achieving such stability is particularly important during in-product storage and product aging. This challenge is particularly apparent for aqueous-based, surfactant-containing products, such as heavy duty liquid laundry detergents. Many “Standard” matrix systems available effectively become “Equilibrium” systems when formulated into aqueous-based products. One may select an “Equilibrium” system or a Reservoir system, which has acceptable in-product diffusion stability and available triggers for release (e.g., friction). “Equilibrium” systems are those in which the perfume and polymer may be added separately to the product, and the equilibrium interaction between perfume and polymer leads to a benefit at one or more consumer touch points (versus a free perfume control that has no polymer-assisted delivery technology). The polymer may also be pre-loaded with perfume; however, part or all of the perfume may diffuse during in-product storage reaching an equilibrium that includes having desired perfume raw materials (PRMs) associated with the polymer. The polymer then carries the perfume to the surface, and release is typically via perfume diffusion. The use of such equilibrium system polymers has the potential to decrease the neat product odor intensity of the neat product (usually more so in the case of pre-loaded standard system). Deposition of such polymers may serve to “flatten” the release profile and provide increased longevity. As indicated above, such longevity would be achieved by suppressing the initial intensity and may enable the formulator to use more high impact or low odor detection threshold (ODT) or low Kovats Index (KI) PRMs to achieve FMOT benefits without initial intensity that is too strong or distorted. It is important that perfume release occurs within the time frame of the application to impact the desired consumer touch point or touch points. Suitable micro-particles and micro-latexes as well as methods of making same may be found in USPA 2005/0003980 A1. Matrix systems also include hot melt adhesives and perfume plastics. In addition, hydrophobically modified polysaccharides may be formulated into the perfumed product to increase perfume deposition and/or modify perfume release. All such matrix systems, including for example polysaccharides and nanolatexes may be combined with other PDTs, including other PAD systems such as PAD reservoir systems in the form of a perfume microcapsule (PMC). Polymer Assisted Delivery (PAD) matrix systems may include those described in the following references: US Patent Applications 2004/0110648 A1; 2004/0092414 A1; 2004/0091445 A1 and 2004/0087476 A1; and U.S. Pat. Nos. 6,531,444; 6,024,943; 6,042,792; 6,051,540; 4,540,721 and 4,973,422.
   Silicones are also examples of polymers that may be used as PDT, and can provide perfume benefits in a manner similar to the polymer-assisted delivery “matrix system”. Such a PDT is referred to as silicone-assisted delivery (SAD). One may pre-load silicones with perfume, or use them as an equilibrium system as described for PAD. Suitable silicones as well as making same may be found in WO 2005/102261; USPA 20050124530A1; USPA 20050143282A1; and WO 2003/015736. Functionalized silicones may also be used as described in USPA 2006/003913 A1. Examples of silicones include polydimethylsiloxane and polyalkyldimethylsiloxanes. Other examples include those with amine functionality, which may be used to provide benefits associated with amine-assisted delivery (AAD) and/or polymer-assisted delivery (PAD) and/or amine-reaction products (ARP). Other such examples may be found in U.S. Pat. No. 4,911,852; USPA 2004/0058845 A1; USPA 2004/0092425 A1 and USPA 2005/0003980 A1.
b.) Reservoir Systems: Reservoir systems are also known as a core-shell type technology, or one in which the fragrance is surrounded by a perfume release controlling membrane, which may serve as a protective shell. The material inside the microcapsule is referred to as the core, internal phase, or fill, whereas the wall is sometimes called a shell, coating, or membrane. Microparticles or pressure sensitive capsules or microcapsules are examples of this technology. Microcapsules of the current invention are formed by a variety of procedures that include, but are not limited to, coating, extrusion, spray-drying, interfacial, in-situ and matrix polymerization. The possible shell materials vary widely in their stability toward water. Among the most stable are polyoxymethyleneurea (PMU)-based materials, which may hold certain PRMs for even long periods of time in aqueous solution (or product). Such systems include but are not limited to urea-formaldehyde and/or melamine-formaldehyde. Gelatin-based microcapsules may be prepared so that they dissolve quickly or slowly in water, depending for example on the degree of cross-linking. Many other capsule wall materials are available and vary in the degree of perfume diffusion stability observed. Without wishing to be bound by theory, the rate of release of perfume from a capsule, for example, once deposited on a surface is typically in reverse order of in-product perfume diffusion stability. As such, urea-formaldehyde and melamine-formaldehyde microcapsules for example, typically require a release mechanism other than, or in addition to, diffusion for release, such as mechanical force (e.g., friction, pressure, shear stress) that serves to break the capsule and increase the rate of perfume (fragrance) release. Other triggers include melting, dissolution, hydrolysis or other chemical reaction, electromagnetic radiation, and the like. The use of pre-loaded microcapsules requires the proper ratio of in-product stability and in-use and/or on-surface (on-situs) release, as well as proper selection of PRMs. Microcapsules that are based on urea-formaldehyde and/or melamine-formaldehyde are relatively stable, especially in near neutral aqueous-based solutions. These materials may require a friction trigger which may not be applicable to all product applications. Other microcapsule materials (e.g., gelatin) may be unstable in aqueous-based products and may even provide reduced benefit (versus free perfume control) when in-product aged. Scratch and sniff technologies are yet another example of PAD. Perfume microcapsules (PMC) may include those described in the following references: US Patent Applications: 2003/0125222 A1; 2003/215417 A1; 2003/216488 A1; 2003/15 8344 A1; 2003/165692 A1; 2004/071742 A1; 2004/071746 A1; 2004/072719 A1; 2004/072720 A1; 2006/0039934 A1; 2003/203829 A1; 2003/195133 A1; 2004/087477 A1; 2004/0106536 A1; and U.S. Pat. Nos. 6,645,479 B1; 6,200,949 B1; 4,882,220; 4,917,920; 4,514,461; 6,106,875 and 4,234,627, 3,594,328 and U.S. RE 32713.

II. Molecule-Assisted Delivery (MAD): Non-polymer materials or molecules may also serve to improve the delivery of perfume. Without wishing to be bound by theory, perfume may non-covalently interact with organic materials, resulting in altered deposition and/or release. Non-limiting examples of such organic materials include but are not limited to hydrophobic materials such as organic oils, waxes, mineral oils, petrolatum, fatty acids or esters, sugars, surfactants, liposomes and even other perfume raw material (perfume oils), as well as natural oils, including body and/or other soils. Perfume fixatives are yet another example. In one aspect, non-polymeric materials or molecules have a CLogP greater than about 2. Molecule-Assisted Delivery (MAD) may also include those described in U.S. Pat. No. 7,119,060 and U.S. Pat. No. 5,506,201.

III. Fiber-Assisted Delivery (FAD): The choice or use of a situs itself may serve to improve the delivery of perfume. In fact, the situs itself may be a perfume delivery technology. For example, different fabric types such as cotton or polyester will have different properties with respect to ability to attract and/or retain and/or release perfume. The amount of perfume deposited on or in fibers may be altered by the choice of fiber, and also by the history or treatment of the fiber, as well as by any fiber coatings or treatments. Fibers may be woven and non-woven as well as natural or synthetic. Natural fibers include those produced by plants, animals, and geological processes, and include but are not limited to cellulose materials such as cotton, linen, hemp jute, flax, ramie, and sisal, and fibers used to manufacture paper and cloth. Fiber-Assisted Delivery may consist of the use of wood fiber, such as thermomechanical pulp and bleached or unbleached kraft or sulfite pulps. Animal fibers consist largely of particular proteins, such as silk, sinew, catgut and hair (including wool). Polymer fibers based on synthetic chemicals include but are not limited to polyamide nylon, PET or PBT polyester, phenol-formaldehyde (PF), polyvinyl alcohol fiber (PVOH), polyvinyl chloride fiber (PVC), polyolefins (PP and PE), and acrylic polymers. All such fibers may be pre-loaded with a perfume, and then added to a product that may or may not contain free perfume and/or one or more perfume delivery technologies. In one aspect, the fibers may be added to a product prior to being loaded with a perfume, and then loaded with a perfume by adding a perfume that may diffuse into the fiber, to the product. Without wishing to be bound by theory, the perfume may absorb onto or be adsorbed into the fiber, for example, during product storage, and then be released at one or more moments of truth or consumer touch points.

IV. Amine Assisted Delivery (AAD): The amine-assisted delivery technology approach utilizes materials that contain an amine group to increase perfume deposition or modify perfume release during product use. There is no requirement in this approach to pre-complex or pre-react the perfume raw material(s) and amine prior to addition to the product. In one aspect, amine-containing AAD materials suitable for use herein may be non-aromatic; for example, polyalkylimine, such as polyethyleneimine (PEI), or polyvinylamine (PVAm), or aromatic, for example, anthranilates. Such materials may also be polymeric or non-polymeric. In one aspect, such materials contain at least one primary amine. This technology will allow increased longevity and controlled release also of low ODT perfume notes (e.g., aldehydes, ketones, enones) via amine functionality, and delivery of other PRMs, without being bound by theory, via polymer-assisted delivery for polymeric amines. Without technology, volatile top notes can be lost too quickly, leaving a higher ratio of middle and base notes to top notes. The use of a polymeric amine allows higher levels of top notes and other PRMS to be used to obtain freshness longevity without causing neat product odor to be more intense than desired, or allows top notes and other PRMs to be used more efficiently. In one aspect, AAD systems are effective at delivering PRMs at pH greater than about neutral. Without wishing to be bound by theory, conditions in which more of the amines of the AAD system are deprotonated may result in an increased affinity of the deprotonated amines for PRMs such as aldehydes and ketones, including unsaturated ketones and enones such as damascone. In another aspect, polymeric amines are effective at delivering PRMs at pH less than about neutral. Without wishing to be bound by theory, conditions in which more of the amines of the AAD system are protonated may result in a decreased affinity of the protonated amines for PRMs such as aldehydes and ketones, and a strong affinity of the polymer framework for a broad range of PRMs. In such an aspect, polymer-assisted delivery may be delivering more of the perfume benefit; such systems are a subspecies of AAD and may be referred to as Amine-Polymer-Assisted Delivery or APAD. In some cases when the APAD is employed in a composition that has a pH of less than seven, such APAD systems may also be considered Polymer-Assisted Delivery (PAD). In yet another aspect, AAD and PAD systems may interact with other materials, such as anionic surfactants or polymers to form coacervate and/or coacervates-like systems. In another aspect, a material that contains a heteroatom other than nitrogen, for example sulfur, phosphorus or selenium, may be used as an alternative to amine compounds. In yet another aspect, the aforementioned alternative compounds can be used in combination with amine compounds. In yet another aspect, a single molecule may comprise an amine moiety and one or more of the alternative heteroatom moieties, for example, thiols, phosphines and selenols. Suitable AAD systems as well as methods of making same may be found in US Patent Applications 2005/0003980 A1; 2003/0199422 A1; 2003/0036489 A1; 2004/0220074 A1 and U.S. Pat. No. 6,103,678.

V. Cyclodextrin Delivery System (CD): This technology approach uses a cyclic oligosaccharide or cyclodextrin to improve the delivery of perfume. Typically a perfume and cyclodextrin (CD) complex is formed. Such complexes may be preformed, formed in-situ, or formed on or in the situs. Without wishing to be bound by theory, loss of water may serve to shift the equilibrium toward the CD-Perfume complex, especially if other adjunct ingredients (e.g., surfactant) are not present at high concentration to compete with the perfume for the cyclodextrin cavity. A bloom benefit may be achieved if water exposure or an increase in moisture content occurs at a later time point. In addition, cyclodextrin allows the perfume formulator increased flexibility in selection of PRMs. Cyclodextrin may be pre-loaded with perfume or added separately from perfume to obtain the desired perfume stability, deposition or release benefit. Suitable CDs as well as methods of making same may be found in USPA 2005/0003980 A1 and 2006/0263313 A1 and U.S. Pat. Nos. 5,552,378; 3,812,011; 4,317,881; 4,418,144 and 4,378,923.

VI. Starch Encapsulated Accord (SEA): The use of a starch encapsulated accord (SEA) technology allows one to modify the properties of the perfume, for example, by converting a liquid perfume into a solid by adding ingredients such as starch. The benefit includes increased perfume retention during product storage, especially under non-aqueous conditions. Upon exposure to moisture, a perfume bloom may be triggered. Benefits at other moments of truth may also be achieved because the starch allows the product formulator to select PRMs or PRM concentrations that normally cannot be used without the presence of SEA. Another technology example includes the use of other organic and inorganic materials, such as silica to convert perfume from liquid to solid. Suitable SEAs as well as methods of making same may be found in USPA 2005/0003980 A1 and U.S. Pat. No. 6,458,754 B1.

In one aspect, SEA's may be made by preparing a mixture comprising starch, water, acid and a perfume, the acid being incorporated in the mixture in an amount sufficient to lower the pH of the starch-water mixture by at least 0.25 units; and atomising and drying the mixture thereby forming encapsulated perfume. In the first step in the process of perfume encapsulation, an aqueous mixture is prepared comprising starch, water, perfume and acid. These ingredients may be added in any order, but usually the starch-water mixture is prepared first and subsequently, either sequentially or together, the acid and perfume are added. When they are added sequentially, the acid may be added prior to the ingredient for encapsulation. Alternatively, the acid is added after the ingredient for encapsulation. The concentration of starch in the aqueous mixture may be from as low as 5 or 10 wt % to as high as 60 or even 75 wt %. Generally the concentration of starch in the mixture is from 20 to 50 wt %, more usually around 25 to 40 wt % in the aqueous mixture.

Suitable starches can be made from raw starch, pregelatinized starch, modified starch derived from tubers, legumes, cereal and grains for example corn starch, wheat starch, rice starch, waxy corn starch, oat starch, cassava starch, waxy barley starch, waxy rice starch, sweet rice starch, amioca, potato starch, tapioca starch and mixtures thereof. Modified starches may be particularly suitable for use in the present invention, and these include hydrolyzed starch, acid thinned starch, starch having hydrophobic groups, such as starch esters of long chain hydrocarbons (C₅ or greater), starch acetates, starch octenyl succinate and mixtures thereof. In one aspect, starch esters, such as starch octenyl succinates are employed.

The term “hydrolyzed starch” refers to oligosaccharide-type materials that are typically obtained by acid and/or enzymatic hydrolysis of starches, preferably corn starch. It may be preferred to include in the starch water-mixture, a starch ester. Particularly preferred are the modified starches comprising a starch derivative containing a hydrophobic group or both a hydrophobic and a hydrophilic group which has been degraded by at least one enzyme capable of cleaving the 1,4 linkages of the starch molecule from the non-reducing ends to produce short chained saccharides to provide high oxidation resistance while maintaining substantially high molecular weight portions of the starch base. The aqueous starch mixture may also include a plasticizer for the starch. Suitable examples include monosaccharides, disaccharides, oligosaccharides and maltodextrins, such as glucose, sucrose, sorbitol, gum arabic, guar gums and maltodextrin.

The acid used in the process of the invention may be any acid. Examples include sulphuric acid, nitric acid, hydrochloric acid, sulphamic acid and phosphonic acid. In one aspect, carboxylic organic acids are employed. In another aspect, organic acids comprising more than one carboxylic acid groups are employed. Examples of suitable organic acids include citric acid, tartaric acid, maleic acid, malic acid, succinic acid, sebacic acid, adipic acid, itaconic acid, acetic acid and ascorbic acid, etc. In one aspect, saturated acids, such as citric acid, are employed.

Suitable perfumes for encapsulation include the HIA perfumes including those having a boiling point determined at the normal standard pressure of about 760 mmHg of 275° C. or lower, an octanol/water partition coefficient P of about 2000 or higher and an odour detection thresholdof less than or equal 50 parts per billion (ppb). In one aspect, the perfume may have logP of 2 or higher. Suitable perfumes may be selected from the group consisting of 3-(4-t-butylphenyl)-2-methyl propanal, 3-(4-t-butylphenyl)-propanal, 3-(4-isopropylphenyl)-2-methylpropanal, methylenedioxyphenyl)-2-methylpropanal, and 2,6-dimethyl-5-heptenal, Alpha-damascone, Delta-damascone, Iso-damascone, Beta-damascenone, 6,7-dihydro-1,1,2,3,3-pentamethyl-4(5H)-indanone, methyl-7,3-dihydro-2H-1,5-benzodioxepine-3-one, 2-[2-(4-methyl-3-cyclohexenyl-1-yl)propyl]cyclopentan-2-one, 2-sec-butylcyclohexanone, and Alpha-dihydro ionone, linalool, ethyllinalool, tetrahydrolinalool, and dihydromyrcenol.

Suitable ingredients can be obtained from Givaudan of Mount Olive, N.J., USA, International Flavors & Fragrances of South Brunswick, N.J., USA, or Quest of Naarden, Netherlands.

Following the formation of the aqueous mixture comprising starch, water, perfumes and acid, the mixture is mixed under high shear to form an emulsion or dispersion of ingredient for encapsulation in the aqueous starch solution.

Any suitable technique may then be used for the final stage of processing where the aqueous mixture including acid and perfumes is atomised and dried. Suitable techniques include, but are not limited to those known in the art including spray drying, extrusion, spray chilling/crystallisation methods, fluid bed coating and the use of phase transfer catalysts to promote interfacial polymerization. Spray efficiencies may be increased by methods known in the art, such as by using high drying towers, lightly oiling the chamber walls, or using preconditioned air in which the moisture has been substantially removed.

VII. Inorganic Carrier Delivery System (ZIC): This technology relates to the use of porous zeolites or other inorganic materials to deliver perfumes. Perfume-loaded zeolite may be used with or without adjunct ingredients used for example to coat the perfume-loaded zeolite (PLZ) to change its perfume release properties during product storage or during use or from the dry situs. Suitable zeolite and inorganic carriers as well as methods of making same may be found in USPA 2005/0003980 A1 and U.S. Pat. Nos. 5,858,959; 6,245,732 B1; 6,048,830 and 4,539,135. Silica is another form of ZIC. Another example of a suitable inorganic carrier includes inorganic tubules, where the perfume or other active material is contained within the lumen of the nano- or micro-tubules. Preferably, the perfume-loaded inorganic tubule (or Perfume-Loaded Tubule or PLT) is a mineral nano- or micro-tubule, such as halloysite or mixtures of halloysite with other inorganic materials, including other clays. The PLT technology may also comprise additional ingredients on the inside and/or outside of the tubule for the purpose of improving in-product diffusion stability, deposition on the desired situs or for controlling the release rate of the loaded perfume. Monomeric and/or polymeric materials, including starch encapsulation, may be used to coat, plug, cap, or otherwise encapsulate the PLT. Suitable PLT systems as well as methods of making same may be found in U.S. Pat. No. 5,651,976.

VIII. Pro-Perfume (PP): This technology refers to perfume technologies that result from the reaction of perfume materials with other substrates or chemicals to form materials that have a covalent bond between one or more PRMs and one or more carriers. The PRM is converted into a new material called a pro-PRM (i.e., pro-perfume), which then may release the original PRM upon exposure to a trigger such as water or light. Pro-perfumes may provide enhanced perfume delivery properties such as increased perfume deposition, longevity, stability, retention, and the like. Pro-perfumes include those that are monomeric (non-polymeric) or polymeric, and may be pre-formed or may be formed in-situ under equilibrium conditions, such as those that may be present during in-product storage or on the wet or dry situs. Nonlimiting examples of pro-perfumes include Michael adducts (e.g., beta-amino ketones), aromatic or non-aromatic imines (Schiffs Bases), oxazolidines, beta-keto esters, and orthoesters. Another aspect includes compounds comprising one or more beta-oxy or beta-thio carbonyl moieties capable of releasing a PRM, for example, an alpha, beta-unsaturated ketone, aldehyde or carboxylic ester. The typical trigger for perfume release is exposure to water; although other triggers may include enzymes, heat, light, pH change, autoxidation, a shift of equilibrium, change in concentration or ionic strength and others. For aqueous-based products, light-triggered pro-perfumes are particularly suited. Such photo-pro-perfumes (PPPs) include but are not limited to those that release coumarin derivatives and perfumes and/or pro-perfumes upon being triggered. The released pro-perfume may release one or more PRMs by means of any of the above mentioned triggers. In one aspect, the photo-pro-perfume releases a nitrogen-based pro-perfume when exposed to a light and/or moisture trigger. In another aspect, the nitrogen-based pro-perfume, released from the photo-pro-perfume, releases one or more PRMs selected, for example, from aldehydes, ketones (including enones) and alcohols. In still another aspect, the PPP releases a dihydroxy coumarin derivative. The light-triggered pro-perfume may also be an ester that releases a coumarin derivative and a perfume alcohol. In one aspect the pro-perfume is a dimethoxybenzoin derivative as described in USPA 2006/0020459 A1. In another aspect the pro-perfume is a 3′, 5′-dimethoxybenzoin (DMB) derivative that releases an alcohol upon exposure to electromagnetic radiation. In yet another aspect, the pro-perfume releases one or more low ODT PRMs, including tertiary alcohols such as linalool, tetrahydrolinalool, or dihydromyrcenol. Suitable pro-perfumes and methods of making same can be found in U.S. Pat. Nos. 7,018,978 B2; 6,987,084 B2; 6,956,013 B2; 6,861,402 B1; 6,544,945 B1; 6,093,691; 6,277,796 B1; 6,165,953; 6,316,397 B1; 6,437,150 B1; 6,479,682 B1; 6,096,918; 6,218,355 B1; 6,133,228; 6,147,037; 7,109,153 B2; 7,071,151 B2; 6,987,084 B2; 6,610,646 B2 and 5,958,870, as well as can be found in USPA 2005/0003980 A1 and USPA 2006/0223726 A1.

Amine Reaction Product (ARP): For purposes of the present application, ARP is a subclass or species of PP. One may also use “reactive” polymeric amines in which the amine functionality is pre-reacted with one or more PRMs to form an amine reaction product (ARP). Typically the reactive amines are primary and/or secondary amines, and may be part of a polymer or a monomer (non-polymer). Such ARPs may also be mixed with additional PRMs to provide benefits of polymer-assisted delivery and/or amine-assisted delivery. Nonlimiting examples of polymeric amines include polymers based on polyalkylimines, such as polyethyleneimine (PEI), or polyvinylamine (PVAm). Nonlimiting examples of monomeric (non-polymeric) amines include hydroxy amines, such as 2-aminoethanol and its alkyl substituted derivatives, and aromatic amines such as anthranilates. The ARPs may be premixed with perfume or added separately in leave-on or rinse-off applications. In another aspect, a material that contains a heteroatom other than nitrogen, for example oxygen, sulfur, phosphorus or selenium, may be used as an alternative to amine compounds. In yet another aspect, the aforementioned alternative compounds can be used in combination with amine compounds. In yet another aspect, a single molecule may comprise an amine moiety and one or more of the alternative heteroatom moieties, for example, thiols, phosphines and selenols. The benefit may include improved delivery of perfume as well as controlled perfume release. Suitable ARPs as well as methods of making same can be found in USPA 2005/0003980 A1 and U.S. Pat. No. 6,413,920 B1.

In one aspect, the amine reaction product's perfume component, which is reacted with the amine to form the amine reaction product, is selected from a perfume comprising a ketone moiety and/or an aldehyde moiety. In one aspect, such perfumes comprise a chain containing at least 5 carbon atoms. In one aspect, suitable perfumes comprising a ketone moiety may be selected from Alpha Damascone, Delta Damascone, Iso Damascone, Carvone, Gamma-Methyl-Ionone, Iso-E-Super, 2,4,4,7-Tetramethyl-oct-6-en-3-one, Benzyl Acetone, Beta Damascone, Damascenone, methyl dihydrojasmonate, methyl cedrylone, and mixtures thereof. In one aspect, suitable perfumes comprising an aldehyde moiety may be selected from 1-decanal, benzaldehyde, florhydral, 2,4-dimethyl-3-cyclohexen-1-carboxaldehyde; cis/trans-3,7-dimethyl-2,6-octadien-1-al; heliotropin; 2,4,6-trimethyl-3-cyclohexene-1-carboxaldehyde; 2,6-nonadienal; alpha-n-amyl cinnamic aldehyde, alpha-n-hexyl cinnamic aldehyde, P.T. Bucinal, lyral, cymal, methyl nonyl, acetaldehyde, hexanal, trans-2-hexenal, and mixture thereof. In one aspect, the suitable perfume may be selected from undecylenic aldehyde, undecalactone gamma, heliotropin, dodecalactone gamma, p-anisic aldehyde, para hydroxy-phenyl-butanone, cymal, benzyl acetone, ionone alpha, p.t.bucinal, damascenone, ionone beta and methyl-nonyl ketone, and/or mixtures thereof. Typically the level of perfume may be from 10% to 90%, from 30% to 85%, or even from 45% to 80% by weight of the amine reaction product. In one aspect, suitable amine reaction products are those resulting from the reaction of polethyleneimine polymer like Lupasol polymers, with one or more of the following Alpha Damascone, Delta Damascone, Carvone, Hedione, Florhydral, Lilial, Heliotropine, Gamma-Methyl-Ionone and 2,4-dimethyl-3-cyclohexen-1-carboxaldehyde; amine reaction products are those resulting from the reaction of Astramol Dendrimers with Carvone and amine reaction products resulting from the reaction of ethyl-4-amino benzoate with 2,4-dimethyl-3-cyclohexen-1-carboxaldehyde. In one aspect, suitable amine reaction products are those resulting from the reaction of Lupasol HF with Delta Damascone; LupasolG35 with Alpha Damascone; LupasolG100 with 2,4-dimethyl-3-cyclohexen-1-carboxaldehyde, ethyl-4-amino benzoate with 2,4-dimethyl-3-cyclohexen-1-carboxaldehyde.

In one aspect, suitable primary and/or secondary amine containing compounds are characterized by an Odor Intensity Index of less than that of a 1% solution of methylanthranilate in dipropylene glycol.

A general structure for a suitable primary amine compound is as follows:

B—(NH₂)ₙ

wherein B is a carrier material, and n is an index of value of at least 1.

Suitable compounds comprising a secondary amine group may have a structure similar to the above excepted that the compound comprises one or more —NH— moieties in addition to any —NH₂ moieties. Thus, such an amine compound may have the formula:

B—(NH₂)ₙ; B—(NH)ₙ; B—(NH)ₙ—(NH₂)ₙ

wherein B is a carrier material, and each n is independently an index of value of at least 1.

In one aspect, B carriers may be inorganic having non-or substantially non carbon based backbones, or organic carriers having essentially carbon bond backbones.

Suitable inorganic carriers include mono or polymers or organic-organosilicon copolymers of amino derivatised organo silane, siloxane, silazane, alumane, aluminum siloxane, or aluminum silicate compounds. Typical examples of such carriers are: organosiloxanes with at least one primary amine moiety like the diaminoalkylsiloxane [H₂NCH₂(CH₃)₂Si]O, or the organoaminosilane (C₆H₅) 3SiNH₂ (described in: Chemistry and Technology of Silicone, W. Noll, Academic Press Inc. 1998, London, pp 209, 106). Mono or polymer or organic-organosilicon copolymers containing one or more organosilylhydrasine moiety are also suitable. A typical example of such a carrier material is N,N′-bis(trimethylsilyl)hydrazine (Me₃Si)₂NNH₂. Typical suitable amines comprising an organic carrier include aminoaryl derivatives, polyamines, aminoacids and derivatives, substituted amines and amides, glucamines, dendrimers and amino-substitued mono-, di-, oligo-, poly-saccharides.

The amine compound may be interrupted or substituted by linkers or cellulose substantive group. A general formula for this amine compound is as follows:

NH₂ₙ-Lₘ-B-Lₘ-R*ₘ;

wherein each m is an index of value 0 or at least 1, and n is an index of value of at least 1 as defined herein before. As can be seen above, the amine group is linked to a carrier molecule as defined by classes hereinafter described. The primary and/or secondary amine group is either directly linked to the carrier group or via a linker group L. The carrier can also be substituted by a R* substituent, and R* can be linked to the carrier either directly or via a linker group L. R* can also contain branching groups like e.g. tertiary amine and amide groups.

It is important for the purpose of the invention that the amine compound comprises at least one primary and/or secondary amine group to react with the perfume aldehyde and/or ketone to form the reaction products. Such reaction is typically known as a Schiff base reaction as a Schiff base is formed. The amine compound is not limited to having only one amine function. Indeed, more preferably, the amine compound comprises more than one amine function, thereby enabling the amine compound to react with several aldehydes and/or ketones. Accordingly, reaction products carrying mixed aldehyde(s) and/or ketone(s) can be achieved, thereby resulting in a mixed release of such fragrances.

### Optional Ingredients

The compositions herein may further comprise a variety of other optional ingredients such as: surfactants, filers, chelating agents, radical scavengers, antioxidants, stabilisers, builders, soil suspending polymer, polymeric soil release agents, dye transfer inhibitor, solvents, suds controlling agents, suds booster, brighteners, perfumes, pigments, dyes and the like.

### Surfactants

The compositions of the present invention may comprise surfactants or a mixture thereof as a highly preferred though optional ingredient The compositions may comprise from 0.01% to 20%, preferably from 0.1% to 15% and more preferably from 0.5% to 8% by weight of the total composition of surfactant or a mixture thereof.

Suitable surfactants for use herein include any nonionic, anionic, zwitterionic, cationic and/or amphoteric surfactants or mixture thereof. Particularly suitable surfactants for use herein are nonionic surfactants such as alkoxylated nonionic surfactants and/or polyhydroxy fatty acid amide surfactants and/or amine oxides and/or zwitterionic surfactants like the zwitterionic betaine surfactants described herein after.

Suitable anionic surfactants include alkyl sulfate surfactant. Preferred alkyl sulfate surfactants include water soluble salts or acids of the formula ROSO₃M wherein R is preferably a C₁₀-C₂₄ hydrocarbyl, preferably an alkyl or hydroxyalkyl having a C₁₀-C₂₀ alkyl component, more preferably a C₁₂-C₁₈ alkyl or hydroxyalkyl, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperidinium cations and quarternary ammonium cations derived from alkylamines such as ethylamine, diethylamine, triethylamine, and mixtures thereof, and the like). Typically, alkyl chains of C₁₂₋₁₆ are preferred for lower wash temperatures (e.g., below about 50° C.) and C₁₆₋₁₈ alkyl chains are preferred for higher wash temperatures (e.g., above about 50° C.).

Suitable anionic surfactants include Alkyl Alkoxylated Sulfate Surfactant. Preferred Alkyl Alkoxylated Sulfate Surfactant include water soluble salts or acids of the formula RO(A)ₘSO₃M wherein R is an unsubstituted C₁₀-C₂₄ alkyl or hydroxyalkyl group having a C₁₀-C₂₄ alkyl component, preferably a C₁₂-C₂₀ alkyl or hydroxyalkyl, more preferably C₁₂-C₁₈ alkyl or hydroxyalkyl, A is an ethoxy or propoxy unit, m is greater than zero, typically between about 0.5 and about 6, more preferably between about 0.5 and about 3, and M is H or a cation which can be, for example, a metal cation (e.g., sodium, potassium, lithium, calcium, magnesium, etc.), ammonium or substituted-ammonium cation. Alkyl ethoxylated sulfates as well as alkyl propoxylated sulfates are contemplated herein. Specific examples of substituted ammonium cations include methyl-, dimethyl-, trimethyl-ammonium and quaternary ammonium cations, such as tetramethyl-ammonium, dimethyl piperidinium and cations derived from alkanolamines such as ethylamine, diethylamine, triethylamine, mixtures thereof, and the like.

Preferred surfactants for use in the compositions according to the present invention are the alkyl sulfates, alkyl alkoxylated sulfates, and mixtures thereof.

Another preferred surfactant system for use in the compositions according to the present invention are acyl sarcosinates surfactants.

Suitable nonionic surfactants include compounds produced by the condensation of alkylene oxide groups (hydrophilic in nature) with an organic hydrophobic compound, which may be aliphatic or alkyl aromatic in nature. The length of the polyoxyalkylene group which is condensed with any particular hydrophobic group can be readily adjusted to yield a water-soluble compound having the desired degree of balance between hydrophilic and hydrophobic elements.

Preferred for use in the present invention are nonionic surfactants such as the polyethylene oxide condensates of alkyl phenols, e.g., the condensation products of alkyl phenols having an alkyl group containing from about 6 to 16 carbon atoms, in either a straight chain or branched chain configuration, with from about 4 to 25 moles of ethylene oxide per mole of alkyl phenol.

Preferred nonionic surfactants are the water-soluble condensation products of aliphatic alcohols containing from 8 to 22 carbon atoms, in either straight chain or branched configuration, with an average of up to 25 moles of ethylene oxide per more of alcohol. Particularly preferred are the condensation products of alcohols having an alkyl group containing from about 9 to 15 carbon atoms with from about 2 to 10 moles of ethylene oxide per mole of alcohol; and condensation products of propylene glycol with ethylene oxide. Most preferred are condensation products of alcohols having an alkyl group containing from about 12 to 15 carbon atoms with an average of about 3 moles of ethylene oxide per mole of alcohol.

The nonionic surfactant system herein can also include a polyhydroxy fatty acid amide component. Polyhydroxy fatty acid amides may be produced by reacting a fatty acid ester and an N-alkyl polyhydroxy amine. The preferred amine for use in the present invention is N—(R¹)—CH₂(CH₂OH)ₐ—CH₂—OH and the preferred ester is a C₁₂-C₂₀ fatty acid methyl ester. Most preferred is the reaction product of N-methyl glucamine with C₁₂-C₂₀ fatty acid methyl ester.

Other suitable surfactants according to the present invention includes also cationic, ampholytic, zwitterionic, and semi-polar surfactants, as well as nonionic surfactants other than those already described herein, including the semi-polar nonionic amine oxides described below.

Cationic detersive surfactants suitable for use in the laundry detergent compositions of the present invention are those having one long-chain hydrocarbyl group. Examples of such cationic surfactants include the ammonium surfactants such as alkyldimethylammonium halogenides, and those surfactants having the formula:

[R²(0R³)y][R⁴(OR³)y]₂R⁵N+X—

wherein R² is an alkyl or alkyl benzyl group having from about 8 to about 18 carbon atoms in the alkyl chain, each R³ is selected from the group consisting of —CH₂CH₂—, —CH₂CH(CH₃)—, —CH₂CH(CH₂OH)—, —CH₂CH₂CH₂—, and mixtures thereof; each R⁴ is selected from the group consisting of C₁-C₄ alkyl, C₁-C₄ hydroxyalkyl, benzyl ring structures formed by joining the two R⁴ groups, —CH₂COH—CHOHCOR₆CHOHCH₂OH wherein R⁶ is any hexose or hexose polymer having a molecular weight less than about 1000, and hydrogen when y is not 0; R⁵ is the same as R⁴ or is an alkyl chain wherein the total number of carbon atoms of R² plus R⁵ is not more than about 18; each y is from 0 to about 10 and the sum of the y values is from 0 to about 15; and X is any compatible anion. Other cationic surfactants useful herein are also described in U.S. Pat. No. 4,228,044, Cambre, issued Oct. 14, 1980, incorporated herein by reference.

Ampholytic surfactants are also suitable for use in the laundry detergent compositions of the present invention. These surfactants can be broadly described as aliphatic derivatives of secondary or tertiary amines, or aliphatic derivatives of heterocyclic secondary and tertiary amines in which the aliphatic radical can be straight- or branched chain. One of the aliphatic substituents contains at least 8 carbon atoms, typically from about 8 to about 18 carbon atoms, and at least one contains an anionic water-solubilizing group e.g. carboxy, sulfonate, sulfate. See U.S. Pat. No. 3,929,678 to Laughlin et al., issued Dec. 30, 1975 at column 19, lines 18-35 (herein incorporated by reference) for examples of ampholytic surfactants.

Zwitterionic surfactants are also suitable for use in laundry detergent compositions. These surfactants can be broadly described as derivatives of secondary and tertiary amines, derivates of heterocyclic secondary and tertiary amines, or derivatives of quaternary ammonium, quarternary phosphonium or tertiary sulfonium compounds. See U.S. Pat. No. 3,929,678 to Laughlin et al., issued Dec. 30, 1975 at columns 19, line 38 through column 22, line 48 (herein incorporated by reference) for examples of zwitterionic surfactants.

Semi-polar nonionic surfactants are a special category of nonionic surfactants which include water-soluble amine oxides containing one alkyl moiety of from about 10 to about 18 carbon atoms and 2 moieties selected from the group consisting of alkyl groups and hydrocyalkyl groups containing form about 1 to about 3 carbon atoms; water-soluble phosphine oxides containing one alkyl moiety of form about 10 to about 18 carbon atoms and 2 moieties selected form the group consisting of alkyl groups and hydroxyalkyl groups containing from about 1 to about 3 carbon atoms. Semi-polar nonionic detergent surfactants include the amine oxide surfactants having the formula R³(OR⁴)ₓNO(R⁵)₂

### Fillers

The compositions of the present invention may comprise a filler salt as a highly preferred though option ingredient. Suitable filler salts herein are selected from the group consisting of sodium sulfate, sodium chloride, sodium tripolyphosphate “STPP” and the like. Typically, the compositions according to the present invention may comprise from up to 75% by weight of the total composition of a filler salt or a mixture thereof, preferably from 70% to 10% and more preferably from 60% to 30%.

### Chelating Agents

The compositions of the present invention may comprise a chelating agent as an optional ingredient. Typically, the compositions according to the present invention comprise up to 5% by weight of the total composition of a chelating agent, or mixtures thereof, preferably from 0.01% to 1.5% by weight and more preferably from 0.01% to 0.5%.

Suitable phosphonate chelating agents for use herein may include alkali metal ethane 1-hydroxy diphosphonates (HEDP), alkylene poly (alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities. Preferred phosphonate chelating agents to be used herein are diethylene triamine penta methylene phosphonate (DTPMP) and ethane 1-hydroxy diphosphonate (HEDP). Such phosphonate chelating agents are commercially available from Monsanto under the trade name DEQUEST®.

Polyfunctionally-substituted aromatic chelating agents may also be useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer have been extensively described in U.S. Pat. No. 4,704,233, Nov. 3, 1987, to Hartman and Perkins. Ethylenediamine N,N′-disuccinic acids is, for instance, commercially available under the tradename ssEDDS® from Palmer Research Laboratories.

Suitable amino carboxylates to be used herein include ethylene diamine tetra acetates, diethylene triamine pentaacetates, diethylene triamine pentaacetate (DTPA), N-hydroxyethylethylenediamine triacetates, nitrilotri-acetates, ethylenediamine tetrapropionates, triethylenetetraaminehexa-acetates, ethanol-diglycines, propylene diamine tetracetic acid (PDTA) and methyl glycine di-acetic acid (MGDA), both in their acid form, or in their alkali metal, ammonium, and substituted ammonium salt forms. Particularly suitable amino carboxylates to be used herein are diethylene triamine penta acetic acid, propylene diamine tetracetic acid (PDTA) which is, for instance, commercially available from BASF under the trade name Trilon FS® and methyl glycine di-acetic acid (MGDA).

Further carboxylate chelating agents to be used herein include salicylic acid, aspartic acid, glutamic acid, glycine, malonic acid or mixtures thereof. Particularly preferred chelating agents to be used herein are amino aminotri(methylene phosphonic acid), di-ethylene-triamino-pentaacetic acid, diethylene triamine penta methylene phosphonate, 1-hydroxy ethane diphosphonate, ethylenediamine N,N′-disuccinic acid, and mixtures thereof.

### Anti-Redeposition Polymer

The compositions according to the present invention may further comprise an anti-redeposition polymer or mixtures thereof, as an optional ingredient.

Suitable anti-redeposition polymers include polymeric polycarboxylates and: polyacrylates polymers, preferably having a weight average molecular weight of from 1,000 Da to 20,000 Da. Suitable anti-redeposition polymers include also co-polymers of maleic acid and acrylic acid, preferably having a molar ratio of maleic acid monomers to acrylic acid monomers of from 1:1 to 1:10 and a weight average molecular weight of from 10,000 Da to 200,000 Da, or preferably having a molar ratio of maleic acid monomers to acrylic acid monomers of from 0.3:1 to 3:1 and a weight average molecular weight of from 1,000 Da to 50,000 Da. Suitable polycarboxylates are the Sokalan CP, PA and HP ranges (BASF) such as Sokalan CP5, PA40 and HP22, and the Alcosperse range of polymers (Alco) such as Alcosperse 725, 747, 408, 412 and 420.

Further suitable anti-redeposition polymers include cellulose derivatives, for example carboxymethyl cellulose, methylhydroxyethyl cellulose, and mixtures thereof. An example of a suitable carboxymethylcellulose is Finnfix® BDA, supplied by CPKelco, Arhem, Netherlands. An example of a suitable methylhydroxymethyl cellulose is Tylose® MH50 G4, supplied by SE Tylose GmbH, Wiesbaden, Germany.

Further suitable anti-redeposition polymers include polyamine polymers known to those skilled in the art. Particularly suitable polyamine polymers for use herein are polyalkoxylated polyamines.

Typically, the compositions comprise up to 10% by weight of the total composition of such a soil suspending polyamine polymer or mixtures thereof, preferably from 0.1% to 5% and more preferably from 0.3% to 2%.

The compositions herein may also comprise other polymeric soil release agents known to those skilled in the art. Such polymeric soil release agents are characterised by having both hydrophilic segments, to hydrophilize the surface of hydrophobic fibres, such as polyester and nylon, and hydrophobic segments, to deposit upon hydrophobic fibres and remain adhered thereto through completion of washing and rinsing cycles and, thus, serve as an anchor for the hydrophilic segments. This can enable stains occurring subsequent to treatment with the soil release agent to be more easily cleaned in later washing procedures.

If utilized, soil release agents will generally comprise from 0.01% to 10.0%, by weight, of the compositions herein, typically from 0.1% to 5%, preferably from 0.2% to 3.0%.

### Dye Transfer Inhibitor

The compositions of the present invention may also include one or more materials effective for inhibiting the transfer of dyes from one dyed surface to another during the cleaning process. Generally, such dye transfer inhibiting agents include polyvinyl pyrrolidone polymers, polyamine N-oxide polymers, co-polymers of N-vinylpyrrolidone and N-vinylimidazole, manganese phthalocyanine, peroxidases, and mixtures thereof. If used, these agents typically comprise from 0.01% to 10% by weight of the composition, preferably from 0.01% to 5%, and more preferably from 0.05% to 2%.

### Brightener

Any optical brighteners, fluorescent whitening agents or other brightening or whitening agents known in the art can be incorporated in the instant compositions when they are designed for fabric treatment or laundering, at levels typically from about 0.05% to about 1.2%, by weight, of the compositions herein.

### Processes of Treating Fabrics

The present invention encompasses a process of treating fabrics which comprises the steps of forming an aqueous bath comprising water, a conventional laundry detergent, preferably a granular laundry detergent, and a particulate bleach additive composition according to the present invention, and subsequently contacting said fabrics with said aqueous bath.

The processes of treating, preferably bleaching, fabrics according to the present invention deliver effective whiteness performance as well as effective stain removal and stain release performance.

The term ‘stain release’ refers to the ability of the composition to modify the surfaces of the textile over multiple wash cycles resulting in reduced adhesion of soils.

The process of treating fabrics herein comprises the steps of forming an aqueous bath comprising water, a conventional laundry detergent and a particulate bleach additive composition, as described herein, subsequently contacting said fabrics with said aqueous bath.

By “conventional laundry detergent” it is meant herein, a laundry detergent composition currently available on the market. Preferably, the conventional laundry detergent comprises at least one surfactant. The laundry detergent compositions may be formulated as particulates (including powders, pearls, granules, tablets and the like), liquids (liquids, gels, and the like) as well as detergent forms based on water-soluble or water-permeable pouches comprising liquids and/or particulates (such as liqui-tabs). Suitable particulate laundry detergent compositions are for example DASH Powder®, ARIEL Tablets®, ARIEL Powder® and other products sold under the trade names ARIEL® or TIDE®.

In a preferred embodiment herein, the conventional laundry detergent is a conventional particulate laundry detergent more preferably a conventional powder, pearl, granule or tablet laundry detergent.

In a preferred embodiment according to the present invention, the conventional laundry detergent as described herein and, the particulate bleach additive composition herein are dissolved or dispersed, preferably substantially dissolved or dispersed, in the aqueous bath formed in the process according to the present invention. By “substantially dissolved or dispersed” it is meant herein, that at least 50%, preferably at least 80%, more preferably at least 90%, even more preferably at least 95%, still more preferably at least 98%, and most preferably at least 99%, of said conventional laundry detergent and/or the particulate bleach additive composition are dissolved or dispersed in the aqueous bath formed in the process according to the present invention.

The particulate bleach additive composition and the conventional detergent composition may be delivered into the washing machine either by charging the dispenser drawer of the washing machine with one or both of the detergents or by directly charging the drum of the washing machine with one or both of the detergents. More preferably the particulate bleach additive composition is directly placed into the drum of the washing machine, preferably using a dosing device, such as a dosing ball (such as the Vizirette®). Even more preferably the particulate bleach additive composition and the conventional detergent composition are both placed into the drum of the washing machine, preferably using suitable dosing devices such as dosing balls, dosing nets etc. The particulate bleach additive composition is preferably delivered to the main wash cycle of the washing machine before, but more preferably at the same time as the conventional detergent composition.

During the processes according to the present invention the particulate bleach additive compositions herein is typically used in dissolved form. By “in dissolved form”, it is meant herein that the particulate bleach additive compositions according to the present invention may be dissolved by the user, preferably in water. The dissolution occurs in a washing machine. Said compositions can be dissolved up to 500 times its own weight, preferably from 5 to 350 times and more preferably from 10 to 200 times.

### Example

| COMPOSITION | I | II | III |
|---|---|---|---|
| Percarbonate | 50.00 | 30.00 | 33.33 |
| TAED | | 9.00 | 4.00 |
| NOBS | 6.67 | 6.67 | 6.67 |
| Blown Powder | 34.98 | 26.70 | 26.70 |
| Mannaway enzyme | | 0.23 | 0.23 |
| Protease enzyme | 0.27 | | 0.20 |
| Termamyl enzyme | 0.27 | | 0.20 |
| Natalase enzyme | 0.27 | | 0.20 |
| Celluclean enzyme | 0.27 | | |
| Blue Speckles | 6.00 | | |
| PEG 45-7 | 0.25 | 0.25 | 0.25 |
| Perfume | 0.24 | 0.24 | 0.24 |
| Starch encapsulated accord | 0.20 | 0.25 | 0.25 |
| Reaction product of | 0.33 | 0.33 | 0.33 |
| δ-damascone and Lupasol | | | |
| Sulphate | 0.26 | 26.66 | 27.40 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A particulate bleaching composition comprising:
a. a bleaching system comprising oxygen bleach and bleach activator;
b. a perfume delivery system chosen among:
i. Polymer Assisted Delivery (PAD);
ii. Molecule-Assisted Delivery (MAD);
iii. Fiber-Assisted Delivery (FAD);
iv. Amine Assisted Delivery (AAD);
v. Cyclodextrin Delivery System (CD);
vi. Starch Encapsulated Accord (SEA);
vii. Inorganic Carrier Delivery System (ZIC);
viii. Pro-Perfume (PP); or mixture thereof.

2. The composition according to claim 1 which comprises from about 10% to about 80% by weight of the total composition of oxygen bleach.

3. A composition according to claim 1, wherein said oxygen bleach is a peroxygen source.

4. The composition according to claim 1, wherein the bleach activator has the formula: 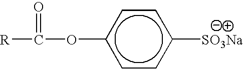
wherein R is an alkyl chain, linear or branched, containing from 1 to 11 carbon atoms

5. The composition according to claim 4, wherein the bleach activator has the formula:

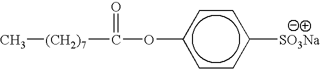

6. A composition according to claim 1 which comprises from about 1% to about 30% by weight of the total composition of a bleach activators,

7. A composition according to claim 1, wherein said composition further comprises a surfactant system selected from the group consisting of nonionic, anionic, zwitterionic, cationic and/or amphoteric surfactants or mixture thereof.

8. The composition according to claim 1, wherein said perfume delivery system is present in an amount from about 0.0001% to about 10%, by weight of the composition.

9. The composition according to claim 1, wherein the perfume delivery system is the product of reaction between a primary and/or secondary amine compound and a perfume component preferably selected from ketone, aldehyde, and mixtures thereof.

10. The composition according to claim 9 wherein said amine compound has the formula selected from:
B—(NH₂)ₙ; B—(NH)ₙ; B—(NH)ₙ—(NH₂)ₙ
wherein B is a carrier material, and each n is independently an index of value of at least 1.

11. The composition according to claim 10 wherein the carrier material B is selected from inorganic or organic carriers, preferably is an organic carrier.

12. The composition according to claim 11 wherein the carrier material B is an amino functionalized polydi-alkylsiloxane.

13. The composition according to claim 12 wherein the organic carrier material B is selected from aminoaryl derivatives, polyamines, aminoacids and derivatives, substituted amines and amides, glucamines, dendrimers, amino-substituted mono-, di, oligo-polysaccharides and/or mixtures thereof.

14. The composition according to claim 1 wherein the perfume delivery system is an encapsulated perfume made by a method comprising the steps of:
a. preparing a mixture comprising starch, water, acid and an perfume, the acid being incorporated in the mixture in an amount sufficient to lower the pH of the starch-water mixture by at least 0.25 units; and
b. atomising and drying the mixture thereby forming encapsulated perfume.

15. The composition according to claim 14 wherein the starch and water are present in the mixture such that the concentration of starch is from about 10 to about 50 wt %.

16. A process of treating fabrics which comprises the steps of forming an aqueous bath comprising water, a conventional laundry detergent, and a particulate bleach additive composition according to claim 1, and subsequently contacting said fabrics with said aqueous bath.
